(19) United States
(12) Patent Application Publication
(10) Pub. No.: US 2026/0212821 A1
(43) Pub. Date: Jul. 23, 2026

(54) DISPLAY DEVICE AND ELECTRONIC DEVICE INCLUDING THE SAME

(71) Applicant: Samsung Display Co., Ltd., Yongin-Si (KR)

(72) Inventors: SUNGSOO CHOI, Yongin-si (KR); JAEHOON LEE, Yongin-si (KR); WONJIN SEO, Yongin-si (KR); JUNPYO LEE, Yongin-si (KR)

(21) Appl. No.: 19/440,679

(22) Filed: Jan. 6, 2026

(30) Foreign Application Priority Data
Jan. 22, 2025 (KR) 10-2025-0009216

(51) Int. Cl. G09G 3/3233

(52) U.S. Cl. CPC G09G 3/3233; G09G 2300/0465; G09G 2300/0819; G09G 2310/08; G09G 2320/0247; G09G 2320/0271; G09G 2330/021

(57) ABSTRACT

A display device may include a display panel including a pixel circuit, a gate driver, an emission driver, a data, and a driving controller. The pixel circuit may include a light emitting element, a first transistor, a second transistor, and a third transistor including a control electrode configured to receive a first initialization gate signal, a first electrode connected to a third node, and a second electrode which receives an initialization voltage. The driving controller may determine a light emitting element off ratio, which is a ratio of a period in which the light emitting element does not emit light within a single frame relative to the length of the single frame, based on a maximum luminance value and may determine a length of an activation period, in which the first initialization gate signal has an activation level within the single frame, based on the light emitting element off ratio.

### CROSS-REFERENCE TO RELATED APPLICATION(S)

This application claims priority under 35 U.S.C. § 119 to Korean Patent Application No. 10-2025-0009216, filed on Jan. 22, 2025 in the Korean Intellectual Property Office KIPO, the contents of which are herein incorporated by reference in their entireties.

### BACKGROUND

### 1. Field

Embodiments of the present inventive concept relate to a display device and an electronic device including the display device.

### 2. Description of the Related Art

Generally, a display device may display an image at a fixed driving frequency (or constant refresh rate), such as about 60 Hz, about 120 Hz, or the like. Recently, a variable refresh rate mode, which changes a driving frequency depending on characteristics of the image or sources of the image (e.g. an application generating image data), has been developed.

In a low frequency driving mode, a single frame may include an address-scan period and a self-scan period. A data voltage may be written to a pixel circuit in the address-scan period and the data voltage may not be written to the pixel circuit in the self-scan period.

In the self-scan period, a voltage of a control electrode of a driving transistor included in the pixel circuit may be decreased by a leakage current or the like. In addition, an initialization voltage may be applied to a source electrode of the driving transistor. The voltage of the control electrode of the driving transistor is decreased, so that a difference between the voltage of the control electrode of the driving transistor and a voltage of the source electrode of the driving transistor may be decreased. Accordingly, in the self-scan period, the pixel circuit may not emit light at a target luminance corresponding to the data voltage written to the pixel circuit in the address-scan period. A flicker may occur and display quality of the display device may be decreased.

### SUMMARY

A feature of the present disclosure is to provide a display device having improved display quality.

Another feature of the present disclosure is to provide an electronic device including the display device.

However, features of the present disclosure are not limited to the above features, and may be variously extended without departing from the spirit and scope of the present disclosure.

According to embodiments, a display device may include a display panel including a pixel circuit, a gate driver configured to provide a gate signal to the pixel circuit, an emission driver configured to provide a first emission signal and a second emission signal to the pixel circuit, a data driver configured to provide a data voltage to the pixel circuit, and a driving controller configured to control the gate driver, the emission driver, and the data driver. The pixel circuit may include a light emitting element, a first transistor including a control electrode connected to a first node, a first electrode connected to a second node, and a second electrode connected to a third node, a second transistor including a control electrode configured to receive a writing gate signal, a first electrode configured to receive the data voltage, and a second electrode connected to the first node, a third transistor including a control electrode configured to receive a first initialization gate signal, a first electrode connected to the third node, and a second electrode configured to receive an initialization voltage, and a first capacitor including a first electrode connected to the first node and a second electrode connected to the third node. The driving controller may be configured to determine a light emitting element off ratio, which is a ratio of a period in which the light emitting element does not emit light within a single frame relative to a length of the single frame, based on a maximum luminance value which is a luminance value corresponding to a maximum gray-level and to determine a length of an activation period, in which the first initialization gate signal has an activation level within the single frame, based on the light emitting element off ratio.

In an embodiment, the light emitting element off ratio may decrease as the maximum luminance value increases.

In an embodiment, the single frame may include an address-scan period and a self-scan period. The driving controller may be configured to determine a length of a first activation period, which is the activation period in which the first initialization gate signal has the activation level in the address-scan period, or a length of a second activation period, which is the activation period in which the first initialization gate signal has the activation level in the self-scan period.

In an embodiment, the length of the second activation period may decrease as the light emitting element off ratio increases.

In an embodiment, the driving controller may be configured to determine the length of the first activation period as a constant length in the address-scan period, regardless of the light emitting element off ratio.

In an embodiment, in the address-scan period, the writing gate signal may have an activation level, the data voltage may be written to the pixel circuit, and the light emitting element may be configured to emit light based on the data voltage. In the self-scan period, the writing gate signal may maintain a deactivation level and the light emitting element may be configured to emit light based on the data voltage written to the pixel circuit in the address-SCAN period.

In an embodiment, the pixel circuit further may include a fourth transistor including a control electrode configured to receive a second initialization gate signal, a first electrode configured to receive a reference voltage, and a second electrode connected to the first node.

In an embodiment, the pixel circuit further may include a fifth transistor including a control electrode configured to receive the first emission signal, a first electrode configured to receive a first power supply voltage, and a second electrode connected to the second node.

In an embodiment, the pixel circuit further may include a sixth transistor including a control electrode configured to receive the first initialization gate signal, a first electrode configured to receive an anode initialization voltage, and a second electrode connected to an anode electrode of the light emitting element.

In an embodiment, the pixel circuit further may include a seventh transistor including a control electrode configured to receive the second emission signal, a first electrode connected to the third node, and a second electrode connected to the anode electrode of the light emitting element.

In an embodiment, the pixel circuit further may include a second capacitor including a first electrode configured to receive the reference voltage and a second electrode connected to the third node.

According to embodiments, a display device may include a display panel including a pixel circuit, a gate driver configured to provide a gate signal to the pixel circuit, an emission driver configured to provide a first emission signal and a second emission signal to the pixel circuit, a data driver configured to provide a data voltage to the pixel circuit, and a driving controller configured to control the gate driver, the emission driver, and the data driver. The pixel circuit may include a light emitting element, a first transistor including a control electrode connected to a first node, a first electrode connected to a second node, and a second electrode connected to a third node, a second transistor including a control electrode configured to receive a writing gate signal, a first electrode configured to receive the data voltage, and a second electrode connected to the first node, a third transistor including a control electrode configured to receive a first initialization gate signal, a first electrode connected to the third node, and a second electrode configured to receive an initialization voltage, and a first capacitor including a first electrode connected to the first node and a second electrode connected to the third node. The driving controller may be configured to determine a light emitting element off ratio, which is a ratio of a period in which the light emitting element does not emit light within a single frame relative to a length of the single frame, based on a maximum luminance value which is a luminance value corresponding to a maximum gray-level and to determine an initialization time, which is a time taken for the third transistor to transmit the initialization voltage to the third node, based on the light emitting element off ratio.

In an embodiment, the light emitting element off ratio may decrease as the maximum luminance value increases.

In an embodiment, the single frame may include an address-scan period and a self-scan period. The driving controller may be configured to determine a first initialization time, which is the initialization time taken for the third transistor to transmit the initialization voltage to the third node in the address-scan period, or a second initialization time, which is the initialization time taken for the third transistor to transmit the initialization voltage to the third node in the self-scan period.

In an embodiment, the second initialization time may decrease as the light emitting element off ratio increases.

In an embodiment, the driving controller may be configured to determine the first initialization time as a constant time in the address-scan period, regardless of the light emitting element off ratio.

According to embodiments, an electronic device may include one or more processors configured to generate a maximum luminance value which is a luminance value corresponding to a maximum gray-level, a display panel including a pixel circuit, a gate driver configured to provide a gate signal to the pixel circuit, an emission driver configured to provide a first emission signal and a second emission signal to the pixel circuit, a data driver configured to provide a data voltage to the pixel circuit, and a driving controller configured to control the gate driver, the emission driver, and the data driver. The pixel circuit may include a light emitting element, a first transistor including a control electrode connected to a first node, a first electrode connected to a second node, and a second electrode connected to a third node, a second transistor including a control electrode configured to receive a writing gate signal, a first electrode configured to receive the data voltage, and a second electrode connected to the first node, a third transistor including a control electrode configured to receive a first initialization gate signal, a first electrode connected to the third node, and a second electrode configured to receive an initialization voltage, and a first capacitor including a first electrode connected to the first node and a second electrode connected to the third node. The driving controller may be configured to receive the maximum luminance value, to determine a light emitting element off ratio, which is a ratio of a period in which the light emitting element does not emit light within a single frame relative to a length of the single frame, based on the maximum luminance value, and to determine a length of an activation period, in which the first initialization gate signal has an activation level within the single frame, based on the light emitting element off ratio.

In an embodiment, the single frame may include an address-scan period and a self-scan period. The driving controller may be configured to determine a length of a first activation period, which is the activation period in which the first initialization gate signal has the activation level in the address-scan period, or a length of a second activation period, which is the activation period in which the first initialization gate signal has the activation level in the self-scan period.

In an embodiment, the length of the second activation period may decrease as the light emitting element off ratio increases.

In an embodiment, the driving controller may be configured to determine the length of the first activation period as a constant length in the address-scan period, regardless of the light emitting element off ratio.

The display device may decrease a luminance change ratio in the self-scan period by allowing the driving controller to determine the light emitting element off ratio based on the maximum luminance value and to determine the length of the second activation period which is the activation period in which the first initialization gate signal has the activation level in the self-scan period based on the light emitting element off ratio. The luminance change ratio decreases in the self-scan period, so that a user of the display device may not be able recognize a difference between a luminance of the address-scan period and a luminance of the self-scan period. Accordingly, display quality of the display device may be improved.

### BRIEF DESCRIPTION OF THE DRAWINGS

Illustrative, non-limiting embodiments will be more clearly understood from the following detailed description in conjunction with the accompanying drawings.

FIG. 1 is a block diagram illustrating a display device according to embodiments.

FIG. 2 is a circuit diagram illustrating an embodiment of a pixel circuit of a display panel included in the display device of FIG. 1.

FIG. 3 is a timing diagram illustrating an embodiment of an operation of the pixel circuit of FIG. 2.

FIG. 4 is a graph illustrating a relationship between a light emitting element off ratio and a luminance change ratio according to a length of an activation period of a first initialization gate signal.

FIG. 5 is a table illustrating the luminance change ratio according to the light emitting element off ratio and the length of the activation period of the first initialization gate signal.

FIG. 6 is a graph illustrating the relationship between the light emitting element off ratio and the luminance change ratio according to cases.

FIG. 7 is a table illustrating the luminance change ratio according to the light emitting element off ratio and the cases.

FIG. 8 is a block diagram illustrating an electronic device according to embodiments.

FIG. 9 is a schematic diagram illustrating the electronic device of FIG. 8.

### DETAILED DESCRIPTION OF THE EMBODIMENTS

Hereinafter, display devices in accordance with embodiments will be described in more detail with reference to the accompanying drawings. The same reference numerals are used for the same components in the drawings, and redundant descriptions of the same components will be omitted.

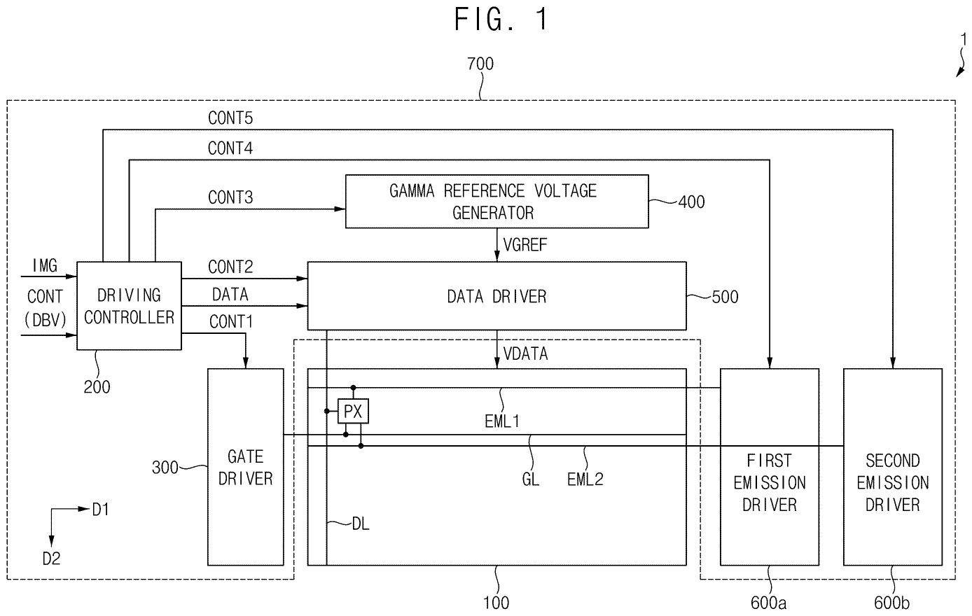

FIG. 1 is a block diagram illustrating a display device 1 according to embodiments.

Referring to FIG. 1, the display device 1 may include a display panel 100 and display panel driver 700. The display panel driver 700 may include a driving controller 200, a gate driver 300, a gamma reference voltage generator 400, a data driver 500, a first emission driver 600a, and a second emission driver 600b.

For example, the driving controller 200 and the data driver 500 may be integrated into a single chip. For example, the driving controller 200, the gamma reference voltage generator 400, and the data driver 500 may be integrated into a single chip. A driving module including at least the driving controller 200 and the data driver 500 which are integrated into the single chip may be referred to as a timing controller embedded data driver (TED).

The display panel 100 may include a display region on which an image is displayed and a peripheral region adjacent to the display region. For example, the peripheral region may be referred to as a bezel.

The display panel 100 may include gate lines GL, first emission lines EML1, second emission lines EML2, data lines DL, and pixel circuits PX. For example, the gate lines GL may extend in a first direction D1, the first emission lines EML1 may extend in the first direction D1, the second emission lines EML2 may extend in the first direction D1, and the data lines DL may extend in a second direction D2 crossing the first direction D1.

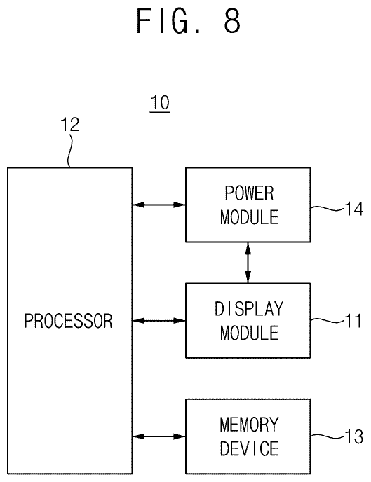

The driving controller 200 may receive input image data IMG and an input control signal CONT from an external device (e.g. a processor of FIG. 8). For example, the input image data IMG may include red image data, green image data, and blue image data. In some embodiments, the input image data IMG may further include white image data. In another example, the input image data IMG may include magenta image data, yellow image data, and cyan image data. The input control signal CONT may include a master clock signal and a data enable signal. The input control signal CONT may further include a vertical synchronizing signal and a horizontal synchronizing signal.

The driving controller 200 may generate a gate control signal CONT1, a data control signal CONT2, a gamma control signal CONT3, a first emission control signal CONT4, a second emission control signal CONT5, and a data signal DATA based on the input image data IMG and the input control signal CONT.

The driving controller 200 may generate the gate control signal CONT1 for controlling an operation of the gate driver 300 based on the input control signal CONT, and may output the gate control signal CONT1 to the gate driver 300. The gate control signal CONT1 may include a vertical start signal and a gate clock signal.

The driving controller 200 may generate the data control signal CONT2 for controlling an operation of the data driver 500 based on the input control signal CONT, and may output the data control signal CONT2 to the data driver 500. The data control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the gamma control signal CONT3 for controlling an operation of the gamma reference voltage generator 400 based on the input control signal CONT, and may output the gamma control signal CONT3 to the gamma reference voltage generator 400.

The driving controller 200 may generate the first emission control signal CONT4 for controlling an operation of the first emission driver 600a based on the input control signal CONT, and may output the first emission control signal CONT4 to the first emission driver 600a.

The driving controller 200 may generate the second emission control signal CONT5 for controlling an operation of the second emission driver 600b based on the input control signal CONT, and may output the second emission control signal CONT5 to the second emission driver 600b.

Although the first emission driver 600a and the second emission driver 600b are disposed at a first side of the display panel 100 in FIG. 1 for convenience of explanation, the present inventive concept may not be limited thereto. For example, the first emission driver 600a and the second emission driver 600b are disposed at a second side of the display panel 100 which is different from the first side. For example, the first emission driver 600a is disposed at the first side of the display panel 100 and the second emission driver 600b is disposed at the second side of the display panel 100. For example, the first emission driver 600a and the second emission driver 600b may be integrally formed.

The gate driver 300 may generate gate signals transmitted to the pixel circuits PX through the gate lines GL in response to the gate control signal CONT1 received from the driving controller 200. The gate driver 300 may output the gate signals to the gate lines GL.

In an embodiment, the gate driver 300 may be integrated on the peripheral region of the display panel 100. In an embodiment, the gate driver 300 may be mounted on the peripheral region of the display panel 100.

The gamma reference voltage generator 400 may generate a gamma reference voltage VGREF in response to the gamma control signal CONT3 received from the driving controller 200. The gamma reference voltage generator 400 may output the gamma reference voltage VGREF to the data driver 500.

In an embodiment, the gamma reference voltage generator 400 may be disposed in the driving controller 200, or in the data driver 500.

The data driver 500 may receive the data control signal CONT2 and the data signal DATA from the driving controller 200, and may receive the gamma reference voltages VGREF from the gamma reference voltage generator 400. The data driver 500 may convert the data signal DATA having a digital type into data voltages having an analog type using the gamma reference voltages VGREF. The data driver 500 may output the data voltages to the data lines DL.

In an embodiment, the data driver 500 may be integrated on the peripheral region of the display panel 100. In an embodiment, the data driver 500 may be mounted on the peripheral region of the display panel 100.

The first emission driver 600a may generate first emission signals transmitted to the pixel circuits PX through the first emission lines EML1 in response to the first emission control signal CONT4 received from the driving controller 200. The first emission driver 600a may output the first emission signals to the first emission lines EML1.

In an embodiment, the first emission driver 600a may be integrated on the peripheral region of the display panel 100. In an embodiment, the first emission driver 600a may be mounted on the peripheral region of the display panel 100.

The second emission driver 600b may generate second emission signals transmitted to the pixel circuits PX through the second emission lines EML2 in response to the second emission control signal CONT5 received from the driving controller 200. The second emission driver 600b may output the second emission signals to the second emission lines EML2.

In an embodiment, the second emission driver 600b may be integrated on the peripheral region of the display panel 100. In an embodiment, the second emission driver 600b may be mounted on the peripheral region of the display panel 100.

In an embodiment, the driving controller 200 may receive a maximum luminance value DBV corresponding to a maximum gray-level from the external device (e.g. the processor of FIG. 8). For example, the input control signal CONT may include the maximum luminance value DBV. The maximum luminance value DBV may be referred to as a display brightness value.

The driving controller 200 may determine a light emitting element off ratio (or referred to as an AMOLED off ratio; AOR). The light emitting element off ratio (AOR) is a ratio of a period in which the light emitting element EE does not emit light within a single frame relative to the length of the single frame.

The driving controller 200 may determine a length of an activation period, in which a first initialization gate signal has an activation level within the single frame, based on the light emitting element off ratio (AOR). For example, a first activation period is the activation period in which a first initialization gate signal has an activation level in an address-scan period and a second activation period is the activation period in which the first initialization gate signal has the activation level in a self-scan period. The driving controller 200 may determine a length of the second activation period which is shorter than a length of the first activation period. An operation of the display device 1 will be described in detail below.

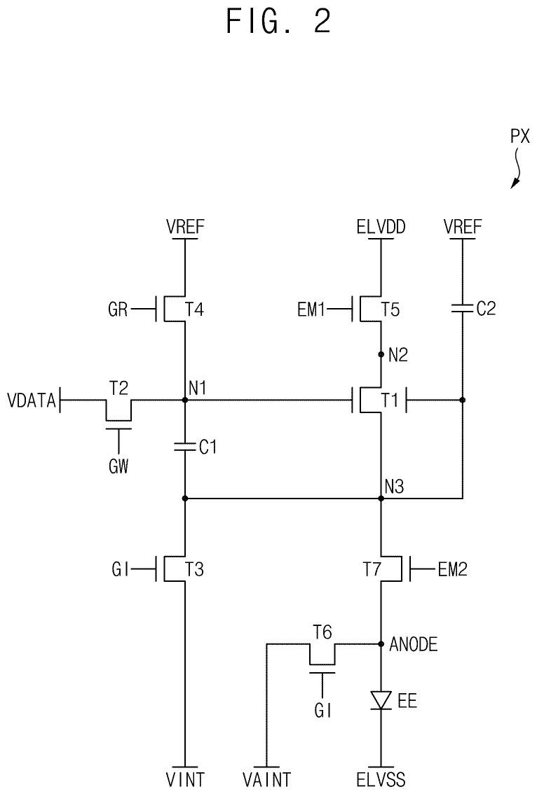

FIG. 2 is a circuit diagram illustrating an embodiment of the pixel circuit PX of the display panel 100 included in the display device 1 of FIG. 1.

Referring to FIG. 2, the pixel circuit PX may include first to third transistors T1 to T3, a first capacitor C1, and a light emitting element EE. The pixel circuit PX may further include fourth to seventh transistors T4 to T7 and a second capacitor C2.

The first transistor T1 may include a control electrode connected to a first node N1, a first electrode connected to a second node N2, and a second electrode connected to a third node N3. The first transistor T1 may generate a driving current based on a data voltage VDATA. The first transistor T1 may be referred to as a driving transistor.

The second transistor T2 may include a control electrode which receives a writing gate signal GW, a first electrode which receives the data voltage VDATA, and a second electrode connected to the first node N1. The second transistor T2 may be referred to as a data writing transistor.

The third transistor T3 may include a control electrode which receives the first initialization gate signal GI, a first electrode connected to the third node N3, and a second electrode which receives an initialization voltage VINT.

The first capacitor C1 may include a first electrode connected to the first node N1 and a second electrode connected to the third node N3. The first capacitor C1 may store the data voltage VDATA. The first capacitor C1 may be referred to as a storage capacitor.

The light emitting element EE may include an anode electrode ANODE and a cathode electrode which receives a second power supply voltage ELVSS. The light emitting element EE may emit light based on the driving current generated by the first transistor T1.

The fourth transistor T4 may include a control electrode which receives a second initialization gate signal GR, a first electrode which receives a reference voltage VREF, and a second electrode connected to the first node N1. The fourth transistor T4 may be referred to as a first initialization transistor.

The fifth transistor T5 may include a control electrode which receives a first emission signal EM1, a first electrode which receives a first power supply voltage ELVDD, and a second electrode connected to the second node N2. The fifth transistor T5 may be referred to as a first emission transistor.

The sixth transistor T6 may include a control electrode which receives the first initialization gate signal GI, a first electrode which receives an anode initialization voltage VAINT, and a second electrode connected to the anode electrode ANODE of the light emitting element EE. The sixth transistor T6 may be referred to as an anode initialization transistor.

The seventh transistor T7 may include a control electrode which receives a second emission signal EM2, a first electrode connected to the third node N3, and a second electrode connected to the anode electrode ANODE of the light emitting element EE. The seventh transistor T7 may be referred to as a second emission transistor.

The second capacitor C2 may include a first electrode which receives the reference voltage VREF and a second electrode connected to the third node N3.

The first transistor T1 may further include a second control electrode connected to the third node N3.

A voltage of the third node N3 is applied to the second control electrode of the first transistor T1, so that shift of a threshold voltage of the first transistor T1, which is caused by stress, may be prevented. Accordingly, stability and reliability of the pixel circuit PX may be improved.

In an embodiment, the first to seventh transistors T1 to T7 may be implemented as N-type transistors, but the first to seventh transistors T1 to T7 are not limited thereto.

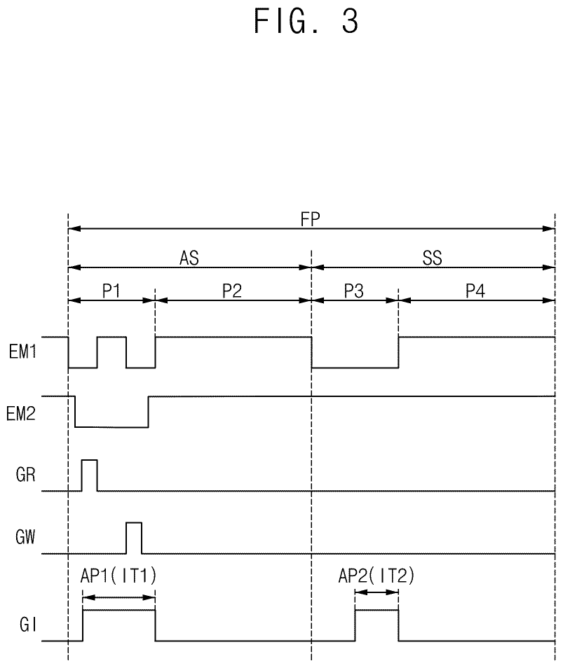

FIG. 3 is a timing diagram illustrating an embodiment of an operation of the pixel circuit PX of FIG. 2.

Referring to FIG. 3, the display device 1 may be operated in a variable refresh rate (VRR) mode which changes a driving frequency depending on characteristics of an image or sources of the image (e.g. an application generating image data).

The number of self-scan periods SS included in the single frame FP may vary according to the driving frequency. For example, when the driving frequency is about 250 Hz which is a maximum driving frequency, the single frame FP may include only one address-scan period AS. For example, when the driving frequency is about 120 Hz, the single frame FP may include one address-scan period AS and one self-scan period SS. For example, when the driving frequency is about 80 Hz, the single frame FP may include one address-scan period AS and two self-scan periods SS. It is assumed that the single frame FP includes one address-scan period AS and one self-scan period SS.

In the address-scan period AS, the writing gate signal GW may have an activation level (e.g. a high level). The second transistor T2 may transmit the data voltage VDATA to the first transistor T1 in response to the writing gate signal GW having the activation level. That is, the data voltage VDATA may be written to the pixel circuit PX. The first transistor T1 may generate the driving current based on the data voltage VDATA. The light emitting element EE may emit light based on the driving current generated by the first transistor T1.

The self-scan period SS may be a next period after the address-scan period AS.

In the self-scan period SS, the writing gate signal GW may maintain a deactivation level (e.g. a low level). The second transistor T2 may be turned off. That is, the data voltage VDATA may not be written to the first transistor T1. The first transistor T1 may generate the driving current based on the data voltage VDATA written to the first transistor T1 in the address-scan period AS. That is, the driving current generated by the first transistor T1 in the self-scan period SS may be identical to the driving current generated by the first transistor T1 in the address-scan period AS. The light emitting element EE may emit light based on the driving current generated by the first transistor T1.

The driving controller 200 may determine the light emitting element off ratio (AOR) based on the maximum luminance value DBV. The driving controller 200 may decreases the light emitting element off ratio (AOR) as the maximum luminance value DBV increases.

In the address-scan period AS, a period in which the light emitting element EE does not emit light may be a first non-emission period P1 and a period in which the light emitting element EE emit light may be a first emission period P2.

In the self-scan period SS, a period in which the light emitting element EE does not emit light may be a second non-emission period P3 and a period in which the light emitting element EE emit light may be a second emission period P4.

A period, in which the first initialization gate signal GI has an activation level in the address-scan period AS, is the first activation period AP1. In addition, in the self-scan period SS, a period, in which the first initialization gate signal GI has the activation level in the self-scan period SS, is the second activation level AP2.

The driving controller 200 may determine a length of the first activation period AP1 and/or a length of the second activation period AP2 based on the light emitting element off ratio (AOR).

In an embodiment, the driving controller 200 may determine the length of the first activation period AP1 as a constant length, regardless of the light emitting element off ratio (AOR). In addition, the driving controller 200 may determine the length of the second activation period AP2 as a length shorter than the length of the first activation period AP1 based on the light emitting element off ratio (AOR).

A length of the first non-emission period P1 may be identical to the a length of the second non-emission period P3. In addition, a length of the first emission period P2 may be identical to the a length of the second emission period P4. The light emitting element off ratio (AOR) may be calculated by [Equation], “AOR=(P1/(P1+P2))*100”, where AOR denotes the light emitting element off ratio (AOR), P1 denotes the length of the first non-emission period P1, and P2 denotes the length of the first emission period P2. In other words, the light emitting element off ratio (AOR) is the length of the first non-emission period P1, in which the light emitting element EE does not emit light, relative to the length of the address-scan period AS.

In the first non-emission period P1, the second initialization gate signal GR may have an activation level (e.g. a high level). The first initialization gate signal GI may have the activation level (e.g. the high level). The first emission signal EM1 may have a deactivation level (e.g. a low level). The second emission signal EM2 may have a deactivation level (e.g. a low level). In addition, the writing gate signal GW may have a deactivation level (e.g. a low level).

The second transistor T2 may be turned off in response to the writing gate signal GW having the deactivation level. The third transistor T3 may be turned on in response to the first initialization gate signal GI having the activation level. The fourth transistor T4 may be turned on in response to the second initialization gate signal GR having the activation level. The fifth transistor T5 may be turned off in response to the first emission signal EM1 having the deactivation level. The sixth transistor T6 may be turned on in response to the first initialization gate signal GI having the activation level. The seventh transistor T7 may be turned off in response to the second emission signal EM2 having the deactivation level.

The fourth transistor T4, which is turned on, may transmit the reference voltage VREF to the first node N1. The first node N1 may be initialized to the reference voltage VREF.

The third transistor T3, which is turned on, may transmit the initialization voltage VINT to the third node N3.

In the first non-emission period P1, a time taken for the third transistor T3 to transmit the initialization voltage VINT to the third node N3 is a first initialization time IT1. The third transistor T3 transmits the initialization voltage VINT to the third node N3 in response to the first initialization gate signal GI having the activation level, so that the first initialization time IT1 may be identical to the length of the first activation period AP1.

The first initialization time IT1 may be a sufficient time for the third transistor T3 to transmit the initialization voltage VINT to the third node N3. Accordingly, at the end of the first activation period AP1, the third node N3 may be initialized to the initialization voltage VINT.

The sixth transistor T6, which is turned on, may transmit the anode initialization voltage VAINT to the anode electrode ANODE of the light emitting element EE. The anode electrode of the light emitting element EE may be initialized to the anode initialization voltage VAINT.

In the first non-emission period P1, the second initialization gate signal GR may change from the activation level to a deactivation level (e.g. a low level). The first initialization gate signal GI may have the activation level. The first emission signal EM1 may have an activation level (e.g. a high level) and the second emission signal EM2 may have the deactivation level. In addition, the writing gate signal GW may have the deactivation level.

The second transistor T2 may be turned off in response to the writing gate signal GW having the deactivation level. The third transistor T3 may be turned on in response to the first initialization gate signal GI having the activation level. The fourth transistor T4 may be turned off in response to the second initialization gate signal GR having the deactivation level. The fifth transistor T5 may be turned on in response to the first emission signal EM1 having the activation level. The sixth transistor T6 may be turned on in response to the first initialization gate signal GI having the activation level. The seventh transistor T7 may be turned off in response to the second emission signal EM2 having the deactivation level.

The fifth transistor T5, which is turned on, may transmit the first power supply voltage ELVDD to the second node N2.

In addition, a difference between a voltage of the first node N1 and the voltage of the third node N3 may be greater than the threshold voltage of the first transistor T1. Accordingly, the first transistor T1 may be turned on. The first transistor T1, which is turned on, may transmit a voltage of the second node N2 to the third node N3. When the difference between the voltage of the first node N1 and the voltage of the third node N3 is identical to the threshold voltage of the first transistor T1, the first transistor T1 may be turned off. The threshold voltage of the first transistor T1 may be compensated for.

In addition, the sixth transistor T6, which is turned on, may transmit the anode initialization voltage VAINT to the anode electrode ANODE of the light emitting element EE. The anode electrode ANODE of the light emitting element EE may be initialized to the anode initialization voltage VAINT.

In the first non-emission period P1, the writing gate signal GW may change from the deactivation level to an activation level (e.g. a high level). The first initialization gate signal GI may have the activation level. The second initialization gate signal GR may have the deactivation level. The first emission signal EM1 may have the deactivation level and the second emission signal EM2 may have the deactivation level.

The second transistor T2 may be turned on in response to the writing gate signal GW having the activation level. The third transistor T3 may be turned on in response to the first initialization gate signal GI having the activation level. The fourth transistor T4 may be turned off in response to the second initialization gate signal GR having the deactivation level. The fifth transistor T5 may be turned off in response to the first emission signal EM1 having the deactivation level. The sixth transistor T6 may be turned on in response to the first initialization gate signal GI having the activation level. The seventh transistor T7 may be turned off in response to the second emission signal EM2 having the deactivation level.

The second transistor T2, which is turned on, may transmit the data voltage VDATA to the first node N1. That is, the data voltage VDATA is written to the pixel circuit PX. The first capacitor C1 may store a difference between the voltage of the first node N1 and the voltage of the third node N3. That is, the first capacitor C1 may store a difference between the data voltage VDATA and the initialization voltage VINT.

The sixth transistor T6, which is turned on, may transmit the anode initialization voltage VAINT to the anode electrode ANODE of the light emitting element EE. The anode electrode ANODE of the light emitting element EE may be initialized to the anode initialization voltage VAINT.

In the first emission period P2, the first emission signal EM1 may have the activation level. The second emission signal EM2 may have an activation level (e.g. a high level). The first initialization gate signal GI may have a deactivation level (e.g. a low level). The second initialization gate signal GR may have the deactivation level. In addition, the writing gate signal GW may have the deactivation level.

The second transistor T2 may be turned off in response to the writing gate signal GW having the deactivation level. The third transistor T3 may be turned off in response to the first initialization gate signal GI having the deactivation level. The fourth transistor T4 may be turned off in response to the second initialization gate signal GR having the deactivation level. The fifth transistor T5 may be turned on in response to the first emission signal EM1 having the activation level. The sixth transistor T6 may be turned off in response to the first initialization gate signal GI having the deactivation level. The seventh transistor T7 may be turned on in response to the second emission signal EM2 having the activation level.

The fifth transistor T5, which is turned on, may transmit the first power supply voltage ELVDD to the second node N2.

The difference between the voltage of the first node N1 and the voltage of the third node N3 may be greater than the threshold voltage of the first transistor T1. Accordingly, the first transistor T1 may be turned on. The first transistor T1, which is turned on, may generate a driving current corresponding to the data voltage VDATA.

The driving current may flow to the light emitting element EE through the seventh transistor T7 which is turned on. Accordingly, the light emitting element EE may emit light at a luminance corresponding to the data voltage VDATA.

In the second non-emission period P3, the first emission signal EM1 may have the deactivation level. The second emission level EM2 may have the activation level. The first initialization gate signal GI may have the activation level. The second initialization gate signal GR may have the deactivation level. The writing gate signal GW may have the deactivation level.

The second transistor T2 may be turned off in response to the writing gate signal GW having the deactivation level. The third transistor T3 may be turned on in response to the first initialization gate signal GI having the activation level. The fourth transistor T4 may be turned off in response to the second initialization gate signal GR having the deactivation level. The fifth transistor T5 may be turned off in response to the first emission signal EM1 having the deactivation level. The sixth transistor T6 may be turned on in response to the first initialization gate signal GI having the activation level. The seventh transistor T7 may be turned on in response to the second emission signal EM2 having the activation level.

In the second non-emission period P3, the length of the second activation period AP2 may be shorter than the length of the first activation period AP1.

The third transistor T3, which is turned on, may transmit the initialization voltage VINT to the third node N3.

In the second non-emission period P3, a time taken for the third transistor T3 to transmit the initialization voltage VINT to the third node N3 is a second initialization time IT2. The third transistor T3 transmits the initialization voltage VINT to the third node N3 in response to the first initialization gate signal GI having the activation level, so that the second initialization time IT2 may be identical to the length of the second activation period AP2.

The second activation period AP2 is shorter than the first activation period AP1, so that the second initialization time IT2 may be shorter than the first initialization time IT1. Accordingly, the initialization voltage VINT may not be fully transmitted during the second initialization time IT2. Accordingly, at the end of the second activation period AP2, the third node N3 may be initialized to a voltage which is higher than the initialization voltage VINT.

The first capacitor C1 may store the difference between the voltage of the first node N1 and the voltage of the third node N3. For example, the first capacitor C1 may store the difference between the data voltage VDATA and the voltage of the third node N3.

The sixth transistor T6, which is turned on, may transmit the anode initialization voltage VAINT to the anode electrode ANODE of the light emitting element EE. The anode electrode ANODE of the light emitting element EE may be initialized to the anode initialization voltage VAINT.

In the second emission period P4, The first emission signal EM1 may have the activation level. The second emission signal EM2 may have the activation level. The first initialization gate signal GI may have the deactivation level. The second initialization gate signal GR may have the deactivation level. The writing gate signal GW may have the deactivation level.

The second transistor T2 may be turned off in response to the writing gate signal GW having the deactivation level. The third transistor T3 may be turned off in response to the first initialization gate signal GI having the deactivation level. The fourth transistor T4 may be turned off in response to the second initialization gate signal GR having the deactivation level. The fifth transistor T5 may be turned on in response to the first emission signal EM1 having the activation level. The sixth transistor T6 may be turned off in response to the first initialization gate signal GI having the deactivation level. The seventh transistor T7 may be turned on in response to the second emission level EM2 having the activation level.

The fifth transistor T5, which is turned on, may transmit the first power supply voltage ELVDD to the second node N2.

The difference between the voltage of the first node N1 and the voltage of the third node N3 may be greater than the threshold voltage of the first transistor T1. Accordingly, the first transistor T1 may be turned on. The first transistor T1, which is turned on, may generate the driving current corresponding to the data voltage VDATA.

The driving current may flow to the light emitting element EE through the seventh transistor T7. Accordingly, the light emitting element EE may emit light at a luminance corresponding to the data voltage VDATA.

In an embodiment, when a level of the first initialization gate signal GI changes from the activation level to the deactivation level in the address-scan period AS, the first node N1 may have the data voltage VDATA. The voltage of the third node N3 is a first source voltage. The difference between the voltage of the first node N1 and the voltage of the third node N3 is a first difference voltage. That is, the driving current, which is generated by the first transistor T1 based on the first difference voltage, is a first driving current.

In the self-scan period SS, the voltage of the first node N1 may be changed due to the leakage current, etc. A changed voltage of the first node N1 is a loss data voltage.

When the level of the first initialization gate signal GI changes from the activation level to the deactivation level in the self-scan period SS, the first node N1 may have the loss data voltage. When the first node N1 has the loss data voltage, the voltage of the third node N3 is a second source voltage. The difference between the voltage of the first node N1 and the voltage of the third node N3 is a second difference voltage in the self-scan period SS. The driving current, which is generated by the first transistor T1 based on the second difference voltage, is a second driving current.

When the length of the first activation period AP1 is identical to the length of the second activation period AP2, the second source voltage may have a first level and the second difference voltage may have a first magnitude.

When the length of the second activation period AP2 is shorter than the length of the first activation period AP1, the second source voltage may have a second level and the second difference voltage may have a second magnitude.

The second magnitude may be greater than the first magnitude. Accordingly, a difference between the first difference voltage and the second difference voltage having the second magnitude may be less than a difference between the first difference voltage and the second difference voltage having the first magnitude. That is, the second difference voltage having the second magnitude may be closer to the first difference voltage than the second difference voltage having the first magnitude.

Accordingly, the second difference voltage having the second magnitude is closer to the first difference voltage, so that the second driving current may be closer to the first driving current. The second driving current is closer to the first driving current, so that a luminance of the address-scan period AS may be similar to a luminance of the self-scan period SS. That is, a luminance change ratio may decrease. The luminance change ratio decreases, so that a user of the display device 1 may not be able to recognize a difference between the luminance of the address-scan period AS and the luminance of the self-scan period SS. Accordingly, flicker may not occur.

In addition, when the length of the second activation period AP2 decreases, the second initialization time IT2, in which the initialization voltage VINT is applied to the pixel circuit PX, may decrease. The second initialization time IT2 decreases, so that power consumption of the display device 1 may be reduced.

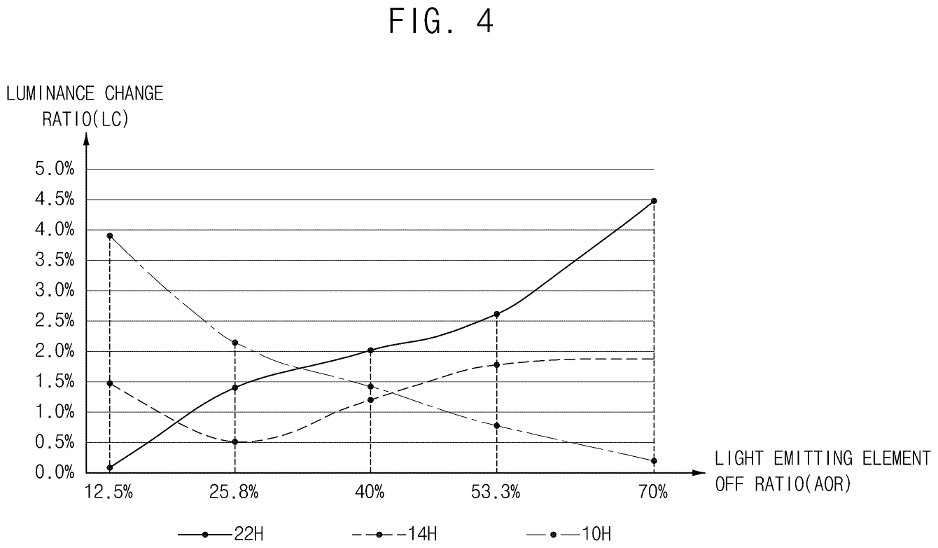

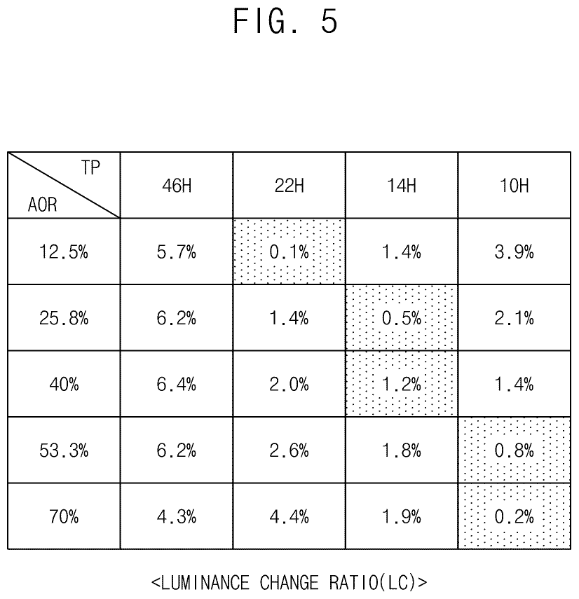

FIG. 4 is a graph illustrating a relationship between the light emitting element off ratio (AOR) and the luminance change ratio LC according to the length of the activation period TP of the first initialization gate signal GI. FIG. 5 is a table illustrating the luminance change ratio LC according to the light emitting element off ratio (AOR) and the length of the activation period TP of the first initialization gate signal GI.

Referring to FIGS. 4 and 5, the luminance change ratio LC may change accordingly to the length of the second activation period AP2 and the light emitting element off ratio (AOR). That is, the length of the second activation period AP2 having a smallest luminance change rate % may vary depending on the light emitting element off ratio (AOR).

The driving controller 200 may determine the length of the first activation period AP1 to the constant length regardless of the light emitting element off ratio (AOR). That is, the length of the first activation period AP1 may not change depending on the light emitting element off ratio (AOR). For example, when the light emitting element off ratio (AOR) is about 12.5%, the length of the first activation period AP1 may be about 46 H. When the light emitting element off ratio (AOR) is about 40%, the length of the first activation period AP1 may be about 46 H. In addition, when the light emitting element off ratio (AOR) is about 70%, the length of the first activation period AP1 may be about 46 H.

The driving controller 200 may determine the length of the second activation period AP2 based on the light emitting element off ratio (AOR). For example, the driving controller 200 may decrease the light emitting element off ratio (AOR) as the maximum luminance value DBV increases. In addition, the driving controller 200 may increase the length of the second activation period AP2 as the light emitting element off ratio (AOR) decreases.

In the second non-emission period P3 of the self-scan period SS, the gate driver 300 may output the first initialization gate signal GI having the length of the second activation period AP2 determined by the driving controller 200.

In an embodiment, it is assumed that the length of the first activation period AP1 is about 46 H and the light emitting element off ratio (AOR) is about 12.5%.

When the length of the second activation period AP2 is about 46 H, the luminance change ratio LC may be about 5.7%. When the length of the second activation period AP2 is about 22 H, the luminance change ratio LC may be about 0.1%. When the length of the second activation period AP2 is about 14 H, the luminance change ratio LC may be about 1.4%. When the length of the second activation period AP2 is about 10 H, the luminance changed ratio LC may be about 3.9%.

That is, when the length of the second activation period AP2 is about 22 H, the luminance change ratio LC may be the smallest. Accordingly, when the light emitting element off ratio (AOR) is about 12.5%, the driving controller 200 may determine the length of the second activation period AP2 as about 22 H. In the second non-emission period P3 of the self-scan period SS, the gate driver 300 may output the first initialization gate signal GI having the length of the second activation period AP2 which is about 22 H.

In an embodiment, it is assumed that the length of the first activation period AP1 is about 46 H and the light emitting element off ratio (AOR) is about 25.8%.

When the length of the second activation period AP2 is about 46 H, the luminance change ratio LC may be about 6.2%. When the length of the second activation period AP2 is about 22 H, the luminance change ratio LC may be about 1.4%. When the length of the second activation period AP2 is about 14 H, the luminance change ratio LC may be about 0.5%. When the length of the second activation period AP2 is about 10 H, the luminance changed ratio LC may be about 2.1%.

That is, when the length of the second activation period AP2 is about 14 H, the luminance change ratio LC may be the smallest. Accordingly, when the light emitting element off ratio (AOR) is about 25.8%, the driving controller 200 may determine the length of the second activation period AP2 as about 14 H. In the second non-emission period P3 of the self-scan period SS, the gate driver 300 may output the first initialization gate signal GI having the length of the second activation period AP2 which is about 14 H.

In an embodiment, it is assumed that the length of the first activation period AP1 is about 46 H and the light emitting element off ratio (AOR) is about 40%.

When the length of the second activation period AP2 is about 46 H, the luminance change ratio LC may be about 6.4%. When the length of the second activation period AP2 is about 22 H, the luminance change ratio LC may be about 2.0%. When the length of the second activation period AP2 is about 14H, the luminance change ratio LC may be about 1.2%. When the length of the second activation period AP2 is about 10 H, the luminance changed ratio LC may be about 1.4%.

That is, when the length of the second activation period AP2 is about 14 H, the luminance change ratio LC may be the smallest. Accordingly, when the light emitting element off ratio (AOR) is about 40%, the driving controller 200 may determine the length of the second activation period AP2 as about 14 H. In the second non-emission period P3 of the self-scan period SS, the gate driver 300 may output the first initialization gate signal GI having the length of the second activation period AP2 which is about 14 H.

In an embodiment, it is assumed that the length of the first activation period AP1 is about 46 H and the light emitting element off ratio (AOR) is about 53.3%.

When the length of the second activation period AP2 is about 46 H, the luminance change ratio LC may be about 6.2%. When the length of the second activation period AP2 is about 22 H, the luminance change ratio LC may be about 2.6%. When the length of the second activation period AP2 is about 14 H, the luminance change ratio LC may be about 1.8%. When the length of the second activation period AP2 is about 10 H, the luminance changed ratio LC may be about 0.8%.

That is, when the length of the second activation period AP2 is about 10 H, the luminance change ratio LC may be the smallest. Accordingly, when the light emitting element off ratio (AOR) is about 53.3%, the driving controller 200 may determine the length of the second activation period AP2 as about 10 H. In the second non-emission period P3 of the self-scan period SS, the gate driver 300 may output the first initialization gate signal GI having the length of the second activation period AP2 which is about 10 H.

In an embodiment, it is assumed that the length of the first activation period AP1 is about 46 H and the light emitting element off ratio (AOR) is about 70%.

When the length of the second activation period AP2 is about 46 H, the luminance change ratio LC may be about 4.3%. When the length of the second activation period AP2 is about 22 H, the luminance change ratio LC may be about 4.4%. When the length of the second activation period AP2 is about 14 H, the luminance change ratio LC may be about 1.9%. When the length of the second activation period AP2 is about 10 H, the luminance changed ratio LC may be about 0.2%.

That is, when the length of the second activation period AP2 is about 10 H, the luminance change ratio LC may be the smallest. Accordingly, when the light emitting element off ratio (AOR) is about 70%, the driving controller 200 may determine the length of the second activation period AP2 as about 10 H. In the second non-emission period P3 of the self-scan period SS, the gate driver 300 may output the first initialization gate signal GI having the length of the second activation period AP2 which is about 10 H.

As described above, the length of the second activation period AP2 having the smallest luminance change rate LC may change depending on the light emitting element off ratio (AOR). Accordingly, the driving controller 200 determines the length of the second activation period AP2 based on the light emitting element off ratio (AOR), so that the luminance change ratio LC may decrease. The luminance change ratio LC decreases, so that the light emitting element EE may accurately emit light at a target luminance. Accordingly, display quality of the display device 1 may be improved.

In addition, the length of the second activation period AP2 may decrease as the light emitting element off ratio (AOR) increases. When the length of the second activation period AP2 decreases, the second initialization time IT2, in which the initialization voltage VINT is applied to the pixel circuit PX, may decrease. The second initialization time IT2 decreases, so that the power consumption of the display device 1 may be reduced.

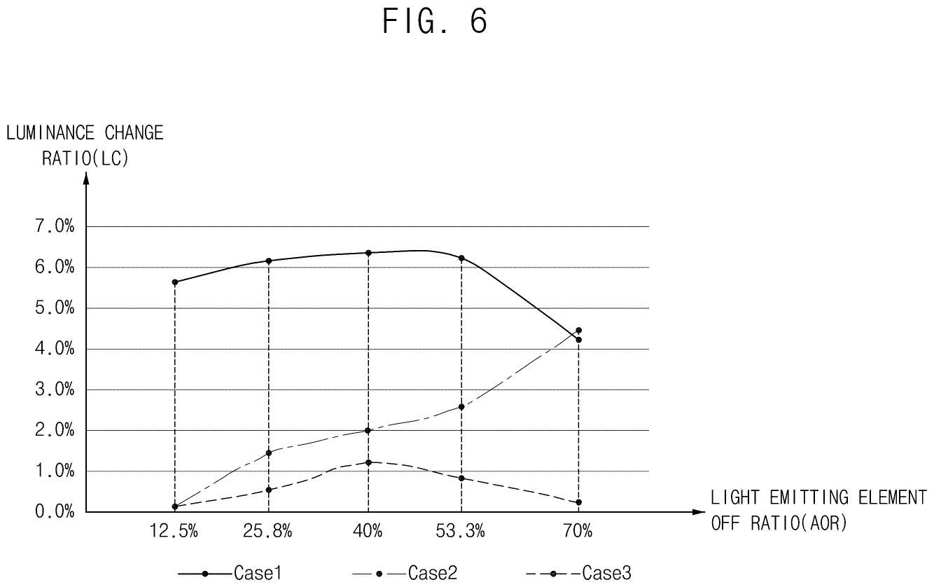

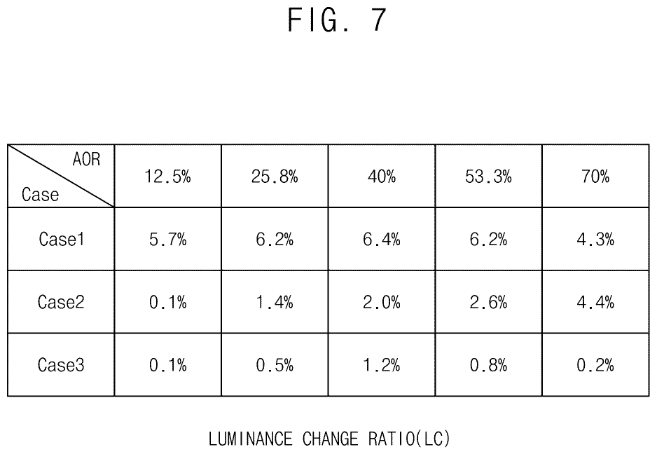

FIG. 6 is a graph illustrating the relationship between the light emitting element off ratio (AOR) and the luminance change ratio LC according to cases. FIG. 7 is a table illustrating the luminance change ratio LC according to the light emitting element off ratio (AOR) and the cases.

Referring to FIGS. 6 and 7, the luminance change ratio LC may change depending on the case Case and the light emitting element off ratio (AOR).

In an embodiment, in a first case Case1, the length of the first activation period AP1 may be about 46 H and the length of the second activation period AP2 may be about 46 H regardless of the light emitting element off ratio (AOR). That is, the length of the first activation period AP1 may be identical to the length of the second activation period AP2.

When the light emitting element off ratio (AOR) is about 12.5%, the luminance change ratio LC may be about 5.7%. When the light emitting element off ratio (AOR) is about 25.8%, the luminance change ratio LC may be about 6.2%. When the light emitting element off ratio (AOR) is about 40%, the luminance change ratio LC may be about 6.4%. When the light emitting element off ratio (AOR) is about 53.3%, the luminance change ratio LC may be about 6.2%. When the light emitting element off ratio (AOR) is about 70%, the luminance change ratio LC may be about 4.3%.

In a second case Case2, the length of the first activation period AP1 may be about 46 H and the length of the second activation period AP2 may be about 22 H regardless of the light emitting element off ratio (AOR). That is, the length of the second activation period AP2 may be shorter than the length of the first activation period AP1.

When the light emitting element off ratio (AOR) is about 12.5%, the luminance change ratio LC may be about 0.1%. When the light emitting element off ratio (AOR) is about 25.8%, the luminance change ratio LC may be about 1.4%. When the light emitting element off ratio (AOR) is about 40%, the luminance change ratio LC may be about 2.0%. When the light emitting element off ratio (AOR) is about 53.3%, the luminance change ratio LC may be about 2.6%. When the light emitting element off ratio (AOR) is about 70%, the luminance change ratio LC may be about 4.4%.

In a third case Case3, the length of the first activation period AP1 may be about 46 H regardless of the light emitting element off ratio (AOR). The length of the second activation period AP2 may change depending on the light emitting element off ratio (AOR). That is, the driving controller 200 may determine the length of the second activation period AP2 based on the light emitting element off ratio (AOR). In addition, the length of the second activation period AP2 may be shorter than the length of the first activation period AP1.

When the light emitting element off ratio (AOR) is about 12.5%, the length of the second activation period AP2 may be about 22 H and the luminance change ratio LC may be about 0.1%. When the light emitting element off ratio (AOR) is about 25.8%, the length of the second activation period AP2 may be about 14 H and the luminance change ratio LC may be about 0.5%. When the light emitting element off ratio (AOR) is about 40%, the length of the second activation period AP2 may be about 14 H and the luminance change ratio LC may be about 1.2%. When the light emitting element off ratio (AOR) is about 53.3%, the length of the second activation period AP2 may be about 10 H and the luminance change ratio LC may be about 0.8%. When the light emitting element off ratio (AOR) is about 70%, the length of the second activation period AP2 may be about 10 H and the luminance change ratio LC may be about 0.2%.

The luminance change ratio LC according to the light emitting element off ratio (AOR) of the second case Case2 may be less than the luminance change ratio LC according to the light emitting element off ratio (AOR) of the first case Case1.

In addition, the luminance change ratio LC according to the light emitting element off ratio (AOR) of the third case Case3 may be less than the luminance change ratio LC according to the light emitting element off ratio (AOR) of the second case Case2.

Accordingly, the luminance change ratio LC according to the light emitting element off ratio (AOR) of the third case Case3 may be the smallest. That is, when the driving controller 200 determines the length of the second activation period AP2 based on the light emitting element off ratio (AOR), the luminance change ratio LC may be the smallest.

As described above, when the driving controller 200 determines the length of the second activation period AP2 based on the light emitting element off ratio (AOR), the luminance change ratio LC may be the smallest. The luminance change ratio LC decreases, so that the light emitting element EE may accurately emit light at the target luminance. Accordingly, the display quality of the display device 1 may be improved.

In addition, the length of the second activation period AP2 may decrease as the light emitting element off ratio (AOR) increases. When the length of the second activation period AP2 decreases, the second initialization time IT2, in which the initialization voltage VINT is applied to the pixel circuit PX, may decrease. The second initialization time IT2 decreases, so that the power consumption of the display device 1 may be reduced.

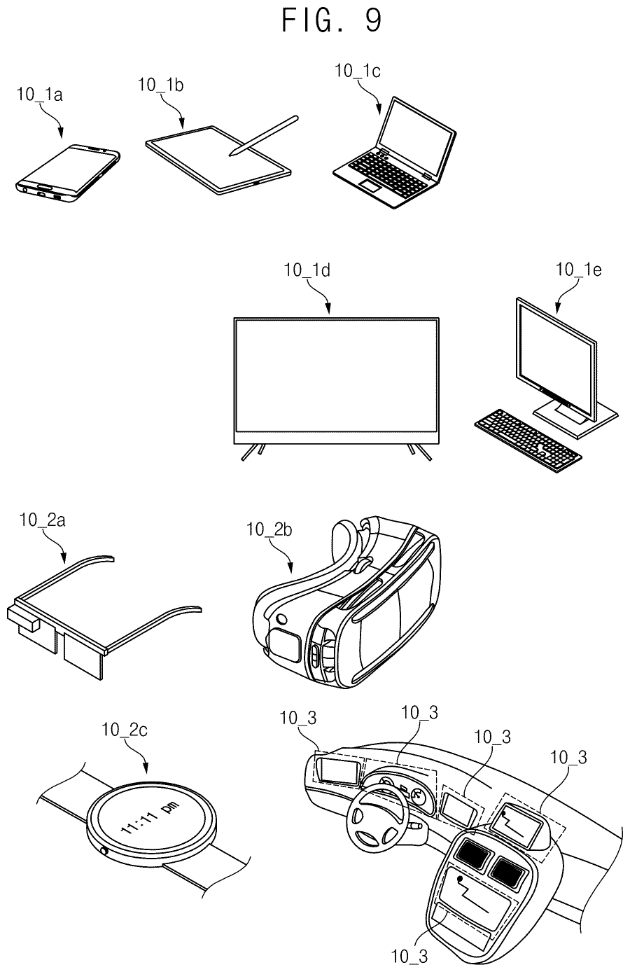

FIG. 8 is a block diagram illustrating an electronic device 10 according to embodiments. FIG. 9 is a schematic diagram illustrating the electronic device 10 of FIG. 8.

Referring to FIG. 8, the electronic device 10 may include a display module 11, a processor 12, a memory device 13, and a power module 14.

The display device 1 may be applied to various electronic devices. In an embodiment, the electronic device 10 may include the display device 1 of FIG. 1. In an embodiment, an operation of the display device 1 included in the electronic device 10 may be the same as an operation of the display device 1 described with reference FIGS. 1 to 7. In an embodiment, the electronic device 10 may further include modules or devices having other additional functions in addition to the display device 1.

The processor 12 may include at least one of a central processing unit (CPU), an application processor (AP), a graphic processing unit (GPU), a communication processor (CP), an image signal processor (ISP), and controller. The processor 12 may include one or more processors.

In an embodiment, the processor 12 may provide the input control signal CONT of FIG. 1 and the input image data IMG of FIG. 1 to the driving controller 200 included in the display device 1 of FIG. 1. In addition, the processor 12 may provide the maximum luminance value DBV, which is the luminance value corresponding to the maximum gray-level, to the driving controller 200. For example, the input control signal CONT may include the maximum luminance value DBV.

In an embodiment, the processor 12 may be provided as two or more forms in terms of functionality or structure. For example, the processor 12 may include a main processor in the form of a first driving chip including the central processing unit and an auxiliary processor in the form of a second driving chip including the controller that receives an image signal from the main processor and processes the image signal to conform interface specifications of the display module 11. The auxiliary processor may include the driving controller 200 included in the display device 1 of FIG. 1. Accordingly, the main processor may provide the input control signal CONT of FIG. 1 and the input image data IMG of FIG. 1 to the auxiliary processor. In addition, the main processor may provide the maximum luminance value DBV, which is the luminance value corresponding to the maximum gray-level, to the auxiliary processor. For example, the input control signal CONT may include the maximum luminance value DBV. The auxiliary processor may process the image signal based on the maximum luminance value DBV, the input control signal CONT and the input image data IMG.

The memory device 13 may include at least one of a non-volatile memory device and a volatile memory device. Data information for an operation of the display module 11 or the processor 12 may be stored in the memory device 13. When the processor 12 executes an application stored in the memory device 13, the input control signal CONT and/or the input image data IMG may be transmitted to the display module 11. The display module 11 may process the input control signal CONT and/or the input image data IMG provided from the processor 12 and may output image information through the display panel.

The power module 14 may include a power supply module, such as a power adapter or a battery device, and a power conversion module that converts power supplied by the power supply module and generates power required for the operation of the electronic device 10.

At least one of the components of the electronic device 10 may be included in the display device 1. In addition, some of individual modules functionally included in one module may be included in the display device 1 and others may be provided separately from the display device 1. For example, the display device 1 may include the display module 11, and the processor 12, the memory device 13, and the power module 14 may be provided in the form of other devices in the electronic device 10, other than the display device.

Referring to FIG. 9, the various electronic devices having the display device 1 may include an image display electronic device such as a smart phone 10_1a, a tablet PC 10_1b, a laptop computer 10_1c, a TV 10_1d, a desk monitor 10_1e, and the like. In addition, the various electronic devices may include a wearable electronic device including the display module such as smart glasses 10_2a, a head mounted display 10_2b, a smart watch 10_2c, and the like. In addition, the various electronic device may include a vehicle electronic device 10_3 including the display module, such as an instrument panel, a center fascia, a center information display (CID) on a dashboard, a room mirror display, and the like. The electronic device 10 is not limited to the image display electronic device, the wearable electronic device and the vehicle electronic device 10_3.

The present inventive concepts may be applied to a display device and an electronic device including the display device. For example, the present inventive concepts may be applied to a television (TV), a digital TV, a 3D TV, a mobile phone, a smart phone, a tablet computer, a laptop computer, a personal computer (PC), a household electronic device, a personal digital assistant (PDA), a portable multimedia player (PMP), a digital camera, a music player, a portable game console, a navigation device, etc.

The foregoing is illustrative of the inventive concept and is not to be construed as limiting thereof. Although a few embodiments of the inventive concept have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific embodiments disclosed, and that modifications to the disclosed embodiments, as well as other embodiments, are intended to be included within the scope of the appended claims. The inventive concept is defined by the following claims, with equivalents of the claims to be included therein.

What is claimed is:

1. A display device comprising:
a display panel including a pixel circuit;
a gate driver configured to provide a gate signal to the pixel circuit;
an emission driver configured to provide a first emission signal and a second emission signal to the pixel circuit;
a data driver configured to provide a data voltage to the pixel circuit; and
a driving controller configured to control the gate driver, the emission driver, and the data driver,
wherein the pixel circuit includes:
a light emitting element;
a first transistor including a control electrode connected to a first node, a first electrode connected to a second node, and a second electrode connected to a third node;
a second transistor including a control electrode configured to receive a writing gate signal, a first electrode configured to receive the data voltage, and a second electrode connected to the first node;
a third transistor including a control electrode configured to receive a first initialization gate signal, a first electrode connected to the third node, and a second electrode configured to receive an initialization voltage; and
a first capacitor including a first electrode connected to the first node and a second electrode connected to the third node, and
wherein the driving controller is configured to determine a light emitting element off ratio, which is a ratio of a period in which the light emitting element does not emit light within a single frame relative to a length of the single frame, based on a maximum luminance value which is a luminance value corresponding to a maximum gray-level and to determine a length of an activation period, in which the first initialization gate signal has an activation level within the single frame, based on the light emitting element off ratio.

2. The display device of claim 1, wherein the light emitting element off ratio decreases as the maximum luminance value increases.

3. The display device of claim 1, wherein the single frame includes an address-scan period and a self-scan period, and
wherein the driving controller is configured to determine a length of a first activation period, which is the activation period in which the first initialization gate signal has the activation level in the address-scan period, or a length of a second activation period, which is the activation period in which the first initialization gate signal has the activation level in the self-scan period.

4. The display device of claim 3, wherein the length of the second activation period decreases as the light emitting element off ratio increases.

5. The display device of claim 4, wherein the driving controller is configured to determine the length of the first activation period as a constant length in the address-scan period, regardless of the light emitting element off ratio.

6. The display device of claim 3, wherein in the address-scan period, the writing gate signal has an activation level, the data voltage is written to the pixel circuit, and the light emitting element is configured to emit light based on the data voltage, and
wherein in the self-scan period, the writing gate signal maintains a deactivation level and the light emitting element is configured to emit light based on the data voltage written to the pixel circuit in the address-scan period.

7. The display device of claim 1, wherein the pixel circuit further includes a fourth transistor including a control electrode configured to receive a second initialization gate signal, a first electrode configured to receive a reference voltage, and a second electrode connected to the first node.

8. The display device of claim 7, wherein the pixel circuit further includes a fifth transistor including a control electrode configured to receive the first emission signal, a first electrode configured to receive a first power supply voltage, and a second electrode connected to the second node.

9. The display device of claim 8, wherein the pixel circuit further includes a sixth transistor including a control electrode configured to receive the first initialization gate signal, a first electrode configured to receive an anode initialization voltage, and a second electrode connected to an anode electrode of the light emitting element.

10. The display device of claim 9, wherein the pixel circuit further includes a seventh transistor including a control electrode configured to receive the second emission signal, a first electrode connected to the third node, and a second electrode connected to the anode electrode of the light emitting element.

11. The display device of claim 10, wherein the pixel circuit further includes a second capacitor including a first electrode configured to receive the reference voltage and a second electrode connected to the third node.

12. A display device comprising:
a display panel including a pixel circuit;
a gate driver configured to provide a gate signal to the pixel circuit;
an emission driver configured to provide a first emission signal and a second emission signal to the pixel circuit;
a data driver configured to provide a data voltage to the pixel circuit; and
a driving controller configured to control the gate driver, the emission driver, and the data driver,
wherein the pixel circuit includes:
a light emitting element;
a first transistor including a control electrode connected to a first node, a first electrode connected to a second node, and a second electrode connected to a third node;
a second transistor including a control electrode configured to receive a writing gate signal, a first electrode configured to receive the data voltage, and a second electrode connected to the first node;
a third transistor including a control electrode configured to receive a first initialization gate signal, a first electrode connected to the third node, and a second electrode configured to receive an initialization voltage; and
a first capacitor including a first electrode connected to the first node and a second electrode connected to the third node, and
wherein the driving controller is configured to determine a light emitting element off ratio, which is a ratio of a period in which the light emitting element does not emit light within a single frame relative to the length of the single frame, based on a maximum luminance value which is a luminance value corresponding to a maximum gray-level and to determine an initialization time, which is a time taken for the third transistor to transmit the initialization voltage to the third node, based on the light emitting element off ratio.

13. The display device of claim 12, wherein the light emitting element off ratio decreases as the maximum luminance value increases.

14. The display device of claim 12, wherein the single frame includes an address-scan period and a self-scan period, and
wherein the driving controller is configured to determine a first initialization time, which is the initialization time taken for the third transistor to transmit the initialization voltage to the third node in the address-scan period, or a second initialization time, which is the initialization time taken for the third transistor to transmit the initialization voltage to the third node in the self-scan period.

15. The display device of claim 14, wherein the second initialization time decreases as the light emitting element off ratio increases.

16. The display device of claim 15, wherein the driving controller is configured to determine the first initialization time as a constant time in the address-scan period, regardless of the light emitting element off ratio.

17. An electronic device comprising:
one or more processors configured to generate a maximum luminance value which is a luminance value corresponding to a maximum gray-level;
a display panel including a pixel circuit;
a gate driver configured to provide a gate signal to the pixel circuit;
an emission driver configured to provide a first emission signal and a second emission signal to the pixel circuit;
a data driver configured to provide a data voltage to the pixel circuit; and
a driving controller configured to control the gate driver, the emission driver, and the data driver,
wherein the pixel circuit includes:
a light emitting element;
a first transistor including a control electrode connected to a first node, a first electrode connected to a second node, and a second electrode connected to a third node;
a second transistor including a control electrode configured to receive a writing gate signal, a first electrode configured to receive the data voltage, and a second electrode connected to the first node;
a third transistor including a control electrode configured to receive a first initialization gate signal, a first electrode connected to the third node, and a second electrode configured to receive an initialization voltage; and
a first capacitor including a first electrode connected to the first node and a second electrode connected to the third node, and
wherein the driving controller is configured to receive the maximum luminance value, to determine a light emitting element off ratio, which is a ratio of a period in which the light emitting element does not emit light within a single frame relative to the length of the single frame, based on the maximum luminance value, and to determine a length of an activation period, in which the first initialization gate signal has an activation level within the single frame, based on the light emitting element off ratio.

18. The electronic device of claim 17, wherein the single frame includes an address-scan period and a self-scan period, and
wherein the driving controller is configured to determine a length of a first activation period, which is the activation period in which the first initialization gate signal has the activation level in the address-scan period, or a length of a second activation period, which is the activation period in which the first initialization gate signal has the activation level in the self-scan period.

19. The electronic device of claim 18, wherein the length of the second activation period decreases as the light emitting element off ratio increases.

20. The electronic device of claim 19, wherein the driving controller is configured to determine the length of the first activation period as a constant length in the address-scan period, regardless of the light emitting element off ratio.
